(19) United States
(12) Patent Application Publication
(10) Pub. No.: US 2008/0055780 A1
(43) Pub. Date: Mar. 6, 2008

(54) Head slider

(75) Inventor: Masaki Kameyama, Kawasaki (JP)

Correspondence Address: Patrick G. Burns;GREER, BURNS & CRAIN, LTD., 300 South Wacker Drive, Suite 2500, Chicago, IL, 60606, US

(73) Assignee: FUJITSU LIMITED

(21) Appl. No.: 11/651,804

(22) Filed: Jan. 9, 2007

(30) Foreign Application Priority Data
Aug. 30, 2006 (JP) 2006-233633

(51) Int. Cl. G11B 5/60

(52) U.S. Cl. 360/236.8

(57) ABSTRACT

A front rail is located near the inflow end of a slider body. The front rail defines a front air bearing surface at a first height from a reference surface of the slider body. A rear rail located near the outflow end of the slider body. The rear rail defines a rear air bearing surface at a second height smaller than the first height from the reference surface. A head element is embedded in the rear air bearing surface. The rear air bearing surface can be distanced from the surface of a recording medium by an amount larger than the distance between the front air bearing surface and the surface of the recording medium. The head element is thus prevented from contact or collision against the recording medium to the utmost even when the head element protrudes out of the rear air bearing surface.

### BACKGROUND OF THE INVENTION

1. Field of the Invention

The present invention relates to ahead slider incorporated in a storage medium drive such as a hard disk drive, HDD.

2. Description of the Prior Art

Front and rear rails are formed on a flying head slider in the hard disk drive, for example. A head element or electromagnetic transducer is embedded in an air bearing surface defined on the rear rail. A magnetic flux is leaked out of the electromagnetic transducer in response to supply of a writing current to a magnetic coil in the electromagnetic transducer. The leaked magnetic flux is applied to a magnetic recording disk. Magnetic bit data is written into the magnetic recording disk in this manner.

The electromagnetic transducer is embedded in an alumina (Al₂O₃) film in the flying head slider. When electric current is supplied to the magnetic coil, the alumina film is caused to expand in response to heat generated at the magnetic coil. This results in protrusion of the electromagnetic transducer from the air bearing surface toward the magnetic recording disk. A relatively large flying height is required to prevent the electromagnetic transducer from contact or collision against the magnetic recording disk. The electromagnetic transducer cannot be allowed to write magnetic bit data of a high density.

### SUMMARY OF THE INVENTION

It is accordingly an object of the present invention to provide a head slider reliably enjoying a reduced flying height.

According to a first aspect of the present invention, there is provided a head slider comprising: a slider body defining a reference surface; a front rail located near the inflow end of the slider body, the front rail defining a front air bearing surface at a first height from the reference surface of the slider body; a rear rail located near the outflow end of the slider body, the rear rail defining a rear air bearing surface at a second height smaller than the first height from the reference surface of the slider body; and a head element embedded in the rear air bearing surface.

The head slider enables the rear air bearing surface defined at the second height from the reference surface. The head element is embedded in the rear air bearing surface. The front air bearing surface is defined at the first height from the reference surface. The first height is set larger than the second height. The rear air bearing surface can be distanced from the surface of a recording medium by an amount larger than the distance between the front air bearing surface and the surface of the recording medium. The head element is thus prevented from contact or collision against the recording medium to the utmost even when the head element protrudes out of the rear air bearing surface.

In this case, the front air bearing surface is set at a position higher than the rear air bearing surface as described above. As long as the head element is kept at a distance from a recording medium as ever, the front air bearing surface is allowed to get closer to the recording medium. Accordingly, the flying height of the head slider can be reduced. The head slider is allowed to enjoy a stable flying attitude.

The head slider may further comprise a pair of rear side rails located near the side edges of the slider body at positions near the outflow end of the slider body, the rear side rails each defining an auxiliary rear air bearing surface at the first height from the reference surface of the slider body. Alternatively, the head slider may further comprise a pair of rear side rails located near the side edges of the slider body at positions near the outflow end of the slider body, the rear side rails each defining an auxiliary rear air bearing surface at a third height from the reference surface of the slier body, the third height being smaller than the first height and larger than the second height.

The head slider enables the auxiliary rear air bearing surfaces defined at positions higher than the rear air bearing surface. The head element is thus prevented from contact or collision against a recording medium to the utmost even when the head element protrudes out of the rear air bearing surface. The auxiliary rear air bearing surfaces is allowed to get closer to the recording medium.

The front and auxiliary rear air bearing surfaces may extend within an imaginary plane getting closer to the reference surface at a position closer to the outflow end and remoter from the inflow end. The front air bearing surface can be distanced from a recording medium by an amount equal to the distance between the auxiliary rear air bearing surfaces in the head slider even when the head slider is kept in an inclined attitude of a predetermined pitch angle. The front and auxiliary rear air bearing surfaces are allowed to get closer to the recording medium.

The head slider may further comprise a protection film formed on the slider body to define the rear air bearing surface, the protection film covering over the head element. The protection film serves to prevent the head element from corrosion in the head slider.

The head slider may further comprise: a first protection film having a first thickness, the first protection film formed on the slider body to define the front air bearing surface; and a second protection film having a second thickness smaller than the first thickness, the second protection film formed on the slider body to define the rear air bearing surface, the second protection film covering over the head element. Adjustment on the thicknesses of the first and second protection films can be utilized to control the first and second heights in a facilitated manner.

According to a second aspect of the present invention, there is provided ahead slider comprising: a slider body defining a reference surface; a front rail located near the inflow end of the slider body, the front rail defining a front air bearing surface at a first height from the reference surface of the slider body; a rear rail located near the outflow end of the slider body, the rear rail defining a rear air bearing surface at the first height from the reference surface of the slider body; and a head element embedded in the rear rail at a second height smaller than the first height from the reference surface of the slider body at a position off the rear air bearing surface.

The head slider enables the front and rear air bearing surfaces defined at the first height from the reference surface. The head element is embedded in the rear rail at the second height smaller than the first height at a position off the rear air bearing surface. The head element can be distanced from the surface of a recording medium by an amount larger than the distance between the rear air bearing surface and the surface of the recording medium. The head element is thus prevented from contact or collision against the recording medium to the utmost even when the head element protrudes out of the rear rail.

In this case, the front and rear air bearing surfaces are defined at positions higher than the head element as described above. As long as the head element is kept at a distance from a recording medium as ever, the front and rear air bearing surfaces are allowed to get closer to the recording medium. Accordingly, the flying height of the head slider can be reduced. The head slider is allowed to enjoy a stable flying attitude.

The head slider may further comprise a pair of rear side rails located near the side edges of the slider body at positions near the outflow end of the slider body, the rear side rails each defining an auxiliary rear air bearing surface at the first height from the reference surface of the slider body. Alternatively, the head slider may further comprise a pair of rear side rails located near the side edges of the slider body at positions near the outflow end of the slider body, the rear side rails each defining an auxiliary rear air bearing surface at a third height from the reference surface of the slier body, the third height being smaller than the first height and larger than the second height.

The head slider enables the auxiliary rear air bearing surfaces defined at positions higher than the head element. The head element is thus prevented from contact or collision against a recording medium to the utmost even when the head element protrudes out of the rear rail. The auxiliary rear air bearing surfaces is allowed to get closer to the recording medium.

The rear and auxiliary rear air bearing surfaces may respectively get closer to the reference surface at positions closer to the side edge of the slider body and remoter from the longitudinal centerline of the slider body, the longitudinal centerline extending from the inflow end to the outflow end. The head slider allows the rear and auxiliary rear air bearing surfaces to get sufficiently close to a recording medium even when the head slider takes an inclined attitude of a predetermined roll angle.

The head slider may further comprise a protection film formed on the slider body to cover over the head element. The protection film serves to prevent the head element from corrosion in the head slider.

The head slider may further comprise: a first protection film having a first thickness, the first protection film formed on the slider body to define the rear air bearing surface; and a second protection film having a second thickness smaller than the first thickness, the second protection film formed on the slider body to cover over the head element. Adjustment on the thicknesses of the first and second protection films can be utilized to control the first and second heights in a facilitated manner.

According to a third aspect of the present invention, there is provided a head slider comprising: a slider body defining a reference surface; a front rail located near the inflow end of the slider body, the front rail defining a front air bearing surface at a first height from the reference surface of the slider body; a rear rail located near the outflow end of the slider body, the rear rail defining a rear air bearing surface at a second height smaller than the first height from the reference surface of the slider body; and a head element embedded in the rear rail at a third height smaller than the second height from the reference surface of the slider body at a position off the rear air bearing surface.

The head slider enables the front air bearing surface defined at the first height from the reference surface. The rear air bearing surface is defined at the second height smaller than the first height from the reference surface. The head element is embedded in the rear rail at the third height smaller than the second height at a position off the rear air bearing surface. The head element can be distanced from the surface of a recording medium by an amount larger than the distance between the front and rear air bearing surfaces and the surface of the recording medium. The head element is thus prevented from contact or collision against the recording medium to the utmost even when the head element protrudes out of the rear rail.

In this case, the front and rear air bearing surfaces are defined at positions higher than the head element as described above. As long as the head element is kept at a distance from a recording medium as ever, the front and rear air bearing surfaces are allowed to get closer to the recording medium. Accordingly, the flying height of the head slider can be reduced. The head slider is allowed to enjoy a stable flying attitude.

The head slider may further comprise a pair of rear side rails located near the side edges of the slider body at position near the outflow end of the slider body, the rear side rails each defining an auxiliary rear air bearing surface at the second height from the reference surface of the slider body. The auxiliary rear air bearing surfaces are defined at positions higher than the head element. The head element is thus prevented from contact or collision against the recording medium to the utmost even when the head element protrudes out of the rear air bearing surface. Moreover, the auxiliary rear air bearing surfaces are allowed to get closer to the recording medium.

The front, rear and auxiliary rear air bearing surfaces may extend within an imaginary plane getting closer to the reference surface at a position closer to the outflow end and remoter from the inflow end. The front air bearing surface can be distanced from a recording medium by an amount equal to the distance between the rear and auxiliary rear air bearing surfaces in the head slider even when the head slider is kept in an inclined attitude of a predetermined pitch angle. The front, rear and auxiliary rear air bearing surfaces are allowed to get closer to the recording medium.

The rear and auxiliary rear air bearing surfaces may respectively get closer to the reference surface at positions closer to the side edge of the slider body and remoter from the longitudinal centerline of the slider body, the longitudinal centerline extending from the inflow end to the outflow end. Simultaneously, the front, rear and auxiliary rear air bearing surfaces may respectively get closer to the reference surface at positions closer to the outflow end and remoter from the inflow end.

The head slider may further comprise a protection film formed on the slider body to cover over the head element in the aforementioned manner. The protection film serves to prevent the head element from corrosion in the head slider.

The head slider may further comprise: a first protection film having a first thickness, the first protection film formed on the slider body to define the rear air bearing surface; and a second protection film having a second thickness smaller than the first thickness, the second protection film formed on the slider body to cover over the head element. Adjustment on the thicknesses of the first and second protection films can be utilized to control the first and second heights in a facilitated manner.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, as an example of a storage medium drive according to the present invention;

FIG. 2 is a perspective view schematically illustrating a flying head slider according to a first embodiment of the present invention;

FIG. 3 is a plan view schematically illustrating the flying head slider;

FIG. 4 is a sectional view taken along the line 4-4 in FIG. 3;

FIG. 5 is a sectional view taken along the line 5-5 in FIG. 3;

FIG. 6 is a sectional view schematically illustrating a diamond-like-carbon (DLC) film formed on a wafer bar and an alumina (Al₂O₃) film;

FIG. 7 is a sectional view schematically illustrating a photoresist film formed on the DLC film;

FIG. 8 is a sectional view schematically illustrating formation of a bottom surface;

FIG. 9 is a plan view schematically illustrating a flying head slider according to a second embodiment of the present invention;

FIG. 10 is a sectional view taken along the line 10-10 in FIG. 9;

FIG. 11 is a sectional view schematically illustrating a flying head slider according to a modification of the second embodiment;

FIG. 12 is a sectional view schematically illustrating the flying head slider flying above a magnetic recording disk;

FIG. 13 is a plan view schematically illustrating a flying head slider according to a third embodiment of the present invention;

FIG. 14 is a sectional view taken along the line 14-14 in FIG. 13;

FIG. 15 is a sectional view taken along the line 15-15 in FIG. 13;

FIG. 16 is a plan view schematically illustrating a flying head slider according to a modification of the third embodiment;

FIG. 17 is a sectional view, corresponding to FIG. 5, schematically illustrating a flying head slider according to another modification of the third embodiment;

FIG. 18 is a sectional view schematically illustrating a flying head slider according to a further modification of the third embodiment;

FIG. 19 is a sectional view taken along the line 19-19 in FIG. 18;

FIG. 20 is a sectional view taken along the line 20-20 in FIG. 18;

FIG. 21 is a sectional view schematically illustrating the flying head slider flying above a magnetic recording disk;

FIG. 22 is a plan view schematically illustrating a flying head slider according to a fourth embodiment of the present invention;

FIG. 23 is a sectional view taken along the line 23-23 in FIG. 22;

FIG. 24 is a sectional view taken along the line 24-24 in FIG. 22;

FIG. 25 is a sectional view schematically illustrating a flying head slider according to a modification of the fourth embodiment;

FIG. 26 is a sectional view schematically illustrating the flying head slider;

FIG. 27 is a sectional view schematically illustrating the flying head slider;

FIG. 28 is a sectional view schematically illustrating a flying head slider according to another modification of the fourth embodiment; and

FIG. 29 is a sectional view schematically illustrating the flying head slider.

### DESCRIPTION OF THE PREFERRED EMBODIMENTS

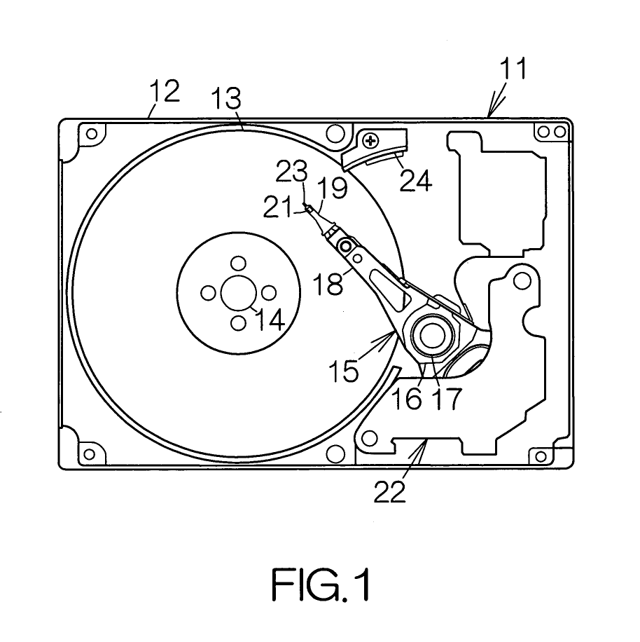

FIG. 1 schematically illustrates the inner structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 are designed to extend in the horizontal direction from the vertical support shaft 17. The carriage block 16 may be made of aluminum, for example. Extrusion molding process may be employed to form the carriage block 16, for example.

A head suspension 19 is attached to the front or tip end of the individual carriage arm 18. The head suspension 19 is designed to extend forward from the carriage arm 18. The head suspension 19 exhibits a force urging the front or tip end thereof toward the surface of the magnetic recording disk 13. A flying head slider 21 is fixed to the tip end of the head suspension 19.

A head element or electromagnetic transducer, not shown, is mounted on the flying head slider 21. The electromagnetic transducer may include a write element and a read element. The write element may include a thin film magnetic head designed to write magnetic bit data into the magnetic recording disk 13 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example.

When the magnetic recording disk 13 rotates, the flying head slider 21 is allowed to receive an airflow generated along the rotating magnetic recording disk 13. The airflow serves to generate a positive pressure or a lift as well as a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

A power source or voice coil motor, VCM, 22 is coupled to the carriage block 16. The voice coil motor 22 serves to drive the carriage block 16 around the vertical support shaft 17. The rotation of the carriage block 16 allows the carriage arms 18 to swing. When the carriage arm 18 swings around the vertical support shaft 17 during the flight of the flying head slider 21, the flying head slider 21 is allowed to move along the radial direction of the magnetic recording disk 13. The electromagnetic transducer on the flying head slider 21 can thus be positioned right above a target recording track on the magnetic recording disk 13.

A load member or tab 23 is attached to the front or tip end of the individual head suspension 19. The load tab 23 is designed to extend further forward from the tip end of the head suspension 19. The swinging movement of the carriage arm 18 allows the load tab 23 to move along the radial direction of the magnetic recording disk 13. A ramp member 24 is located on the movement path of the load tab 23 in a space outside the magnetic recording disk 13. The tip end of the ramp member 24 is opposed to a non-data zone outside the outermost recording track on the magnetic recording disk 13. The ramp member 24 and the load tabs 23 in combination establish a so-called load/unload mechanism. The ramp member 24 may be made of a hard plastic material, for example.

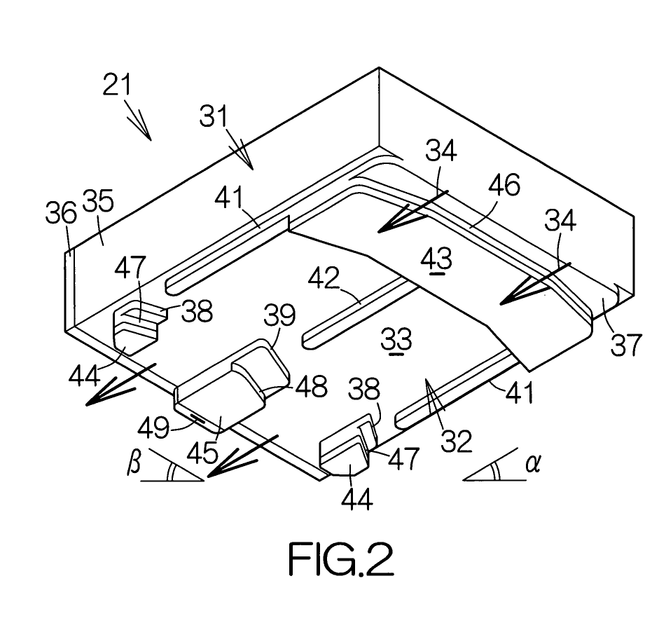

FIG. 2 illustrates the flying head slider 21 according to a first embodiment of the present invention. The flying head slider 21 includes a slider body 31 in the form of a flat parallelepiped. A medium-opposed surface or bottom surface 32 is defined over the slider body 31 so as to face the magnetic recording disk 13 at a distance. A flat reference surface or base surface 33 is defined on the bottom surface 32. When the magnetic recording disk 13 rotates, airflow 34 acts on the bottom surface 32 in the direction from the inflow or leading end toward the outflow or trailing end of the slider body 31. The slider body 31 may comprise a base 35 made of Al₂O₃—TiC and a head protection film 36 made of Al₂O₃ (alumina), for example. The head protection film 36 is overlaid on the outflow or trailing end of the base 35.

A front rail 37 stands upright from the base surface 33 of the bottom surface 32 near the inflow end of the slider body 31. The front rail 37 is designed to extend along the inflow end of the base surface 33 in the lateral direction extending across the airflow 34. A pair of rear side rails 38, 38 likewise stand upright from the base surface 33 near the outflow end of the slider body 31. The rear side rails 38 are located along the side edges of the base surface 33. A rear center rail 39 stands upright from the base surface 33 in a space between the rear side rails 38. The rear center rail 39 is designed to extend in the longitudinal direction running from the outflow end to the inflow end of the base surface 33.

A pair of side rails 41, 41 is connected to the front rail 37. The side rails 41, 41 stand upright from the base surface 33. The side rails 41, 41 are designed to extend along the side edges of the base surface 33 in the longitudinal direction from the front rail 37 toward the rear side rails 38, 38, respectively. The side rails 41, 41 fail to reach the corresponding rear side rails 38, 38. Airflow paths are defined between the side rails 41 and the corresponding rear side rails 38.

A center rail 42 is likewise connected to the front rail 37. The center rail 42 stands upright from the base surface 33. The center rail 42 is designed to extend in a space between the side rails 41, 41 in the longitudinal direction from the front rail 37 toward the rear center rail 39. The center rail 42 fails to reach the rear center rail 39. The side rails 41, 41 and the center rail 42 may extend in parallel with each other.

A front air bearing surface 43 is defined on the top surface of the front rail 37. An auxiliary rear air bearing surface 44 is likewise defined on the top surface of the individual rear side rail 38. A rear air bearing surface 45 is defined on the top surface of the rear center rail 39. Steps 46, 47, 48 serves to connect the air bearing surfaces 43, 44, 45 to the corresponding top surfaces of the rails 37, 38, 39, respectively. The aforementioned electromagnetic transducer 49 is mounted on the slider body 31. The electromagnetic transducer 49 is embedded in the head protection film 36 of the slider body 31. The read and write gaps of the electromagnetic transducer 49 are exposed at the rear air bearing surface 45 of the rear center rail 39.

A heater, not shown, is incorporated in the rear center rail 39 at a position adjacent to the electromagnetic transducer 49. The heater generates heat to cause expansion of the head protection film 36. The expansion of the head protection film 36 allows the electromagnetic transducer 49 to protrude on the rear center rail 39. The protrusion of the electromagnetic transducer 49 is utilized to adjust the lying height of the read and write gaps.

When the magnetic recording disk 13 rotates, the airflow 34 is generated along the surface of the rotating magnetic recording disk 13. The front air bearing surface 43 establishes a positive pressure or lift larger than that of the auxiliary rear air bearing surfaces 44 and the rear air bearing surface 45. When the flying head slider 21 flies above the surface of the rotating magnetic recording disk 13, the flying head slider 21 can be kept at an inclined attitude of the pitch angle α. The term “pitch angle” is used to define an inclined angle in the longitudinal direction of the slider body 31 along the direction of the airflow 34.

The swinging movement of the carriage arm 18 during the rotation of the magnetic recording disk 13 allows the movement of the flying head slider 21 in the radial direction of the magnetic recording disk 13, for example. The side of the slider body 31 receives airflow. The flying head slider 21 takes an inclined attitude of the roll angle β. The term “roll angle” is used to define an inclined angle in the lateral direction of the slider body 31 perpendicular to the longitudinal direction.

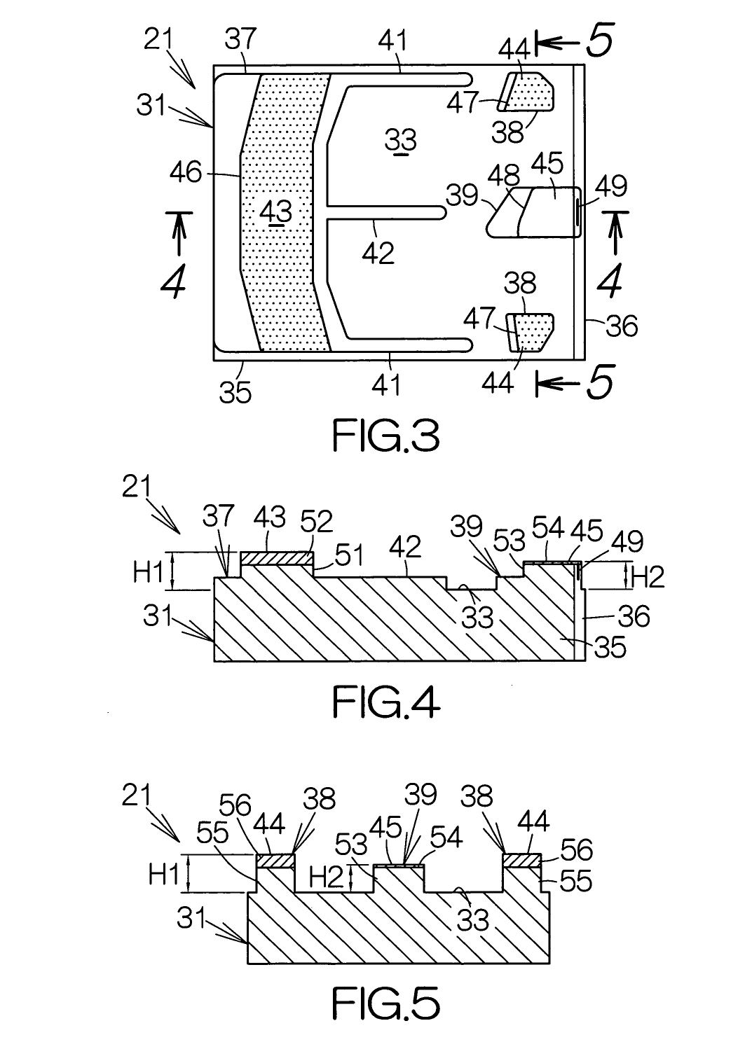

As mentioned in FIG. 3, the front air bearing surface 43 and the auxiliary rear air bearing surfaces 44, 44 extend at the highest level from the base surface 33 in the flying head slider 21. As shown in FIG. 4, the front air bearing surface 43 is set at a first height H1 from the base surface 33. The front rail 37 includes a front pedestal 51 shaped in the slider body 31 and a first protection film 52 formed on the front pedestal 51. The first protection film 52 has a first thickness. The surface of the first protection film 52 serves to provide the aforementioned front air bearing surface 43. The first protection film 52 may be made of diamond-like-carbon (DLC), for example.

The rear air bearing surface 45 is set at a second height H2 smaller than the first height H1 from the base surface 33. The rear center rail 39 includes a rear pedestal 53 shaped in the slider body 31 and a second protection film 54 formed on the rear pedestal 53. The second protection film 54 has a second thickness smaller than the first thickness. The surface of the second protection film 54 serves to provide the aforementioned rear air bearing surface 45. The second protection film 54 may be made of diamond-like-carbon (DLC), for example. The second protection film 54 covers over the front end of the electromagnetic transducer 49 on the rear center rail 39.

As shown in FIG. 5, the auxiliary rear air bearing surfaces 44 are set at the first height H1 from the base surface 33 in the same manner as the front air bearing surface 43. The front air bearing surface 43 and the auxiliary rear air bearing surfaces 44 thus extend within an imaginary plane, not shown, extending in parallel with the base surface 33 at the first height H1 from the base surface 33. Each of the rear side rails 38 includes a side pedestal 55 shaped in the slider body 31 and a third protection film 56 formed on the side pedestal 55. The third protection film 56 has the first thickness. The surface of the third protection film 56 serves to provide the aforementioned auxiliary rear air bearing surface 44. The third protection film 56 may be made of diamond-like-carbon (DLC), for example.

The height from the base surface 33 is set equal for the front, rear and side pedestals 51, 53, 55. Accordingly, the difference between the first height H1 and the second height H2 corresponds to the difference between the thickness of the first and third protection films 52, 56 and that of the second protection film 54. Assume that a magnetic coil generates heat in the electromagnetic transducer 49 in response to supply of electric current to the magnetic coil, for example. The heat of the magnetic coil serves to cause expansion of the head protection film 36. This results in protrusion of the electromagnetic transducer 49 on the rear center rail 39. The difference between the thickness of the first and third protection films 52, 56 and that of the second protection film 54 may be set equal to the maximum amount of the protrusion of the electromagnetic transducer 49, for example.

The rear air bearing surface 45 is set at the second height H2 from the base surface 33 in the flying head slide 21. The electromagnetic transducer 49 is embedded in the rear air bearing surface 45. The front air bearing surface 43 and the auxiliary rear air bearing surfaces 44, 44 are set at the first height H1 larger than the second height H2 from the base surface 33. The rear air bearing surface 45 is distanced from the surface of the magnetic recording disk 13 by an amount larger than the distance between the auxiliary rear air bearing surfaces 44 and the surface of the magnetic recording disk 13. The electromagnetic transducer 49 is thus prevented from contact or collision against the magnetic recording disk 13 to the utmost even when the electromagnetic transducer 49 protrudes out of the rear air bearing surface 45 in response to the expansion of the head protection film 36.

The front and auxiliary rear air bearing surfaces 43, 44, 44 are set at the first height H1 larger than the second height H2 of the rear air bearing surface 45 as described above. As long as the electromagnetic transducer 49 is kept at a distance from the magnetic recording disk 13 as ever, the front and auxiliary rear air bearing surfaces 43, 44, 44 are allowed to get closer to the magnetic recording disk 13. Accordingly, the flying height of the flying head slider 21 can be reduced. The flying head slider 21 is allowed to enjoy a stable flying attitude. In addition, the second protection film 54 covers over the electromagnetic transducer 49. The second protection film 54 is allowed to have a sufficient thickness, so that the second protection film 54 serves to prevent corrosion of the electromagnetic transducer 49.

A brief description will be made on a method of making the flying head slider 21. An alumina Al₂O₃ film is first overlaid on a wafer made of Al₂O₃—TiC. An electromagnetic transducer is formed in the alumina film. A wafer bar is subsequently cut out of the wafer. A bottom surface is then formed on the cutting surface of the wafer bar. As shown in FIG. 6, a diamond-like-carbon (DLC) film 59 having the aforementioned second thickness is formed over the flat surfaces of the wafer bar 57 and the alumina film 58 so as to form the bottom surface. A DLC film 61 is then formed on the surface of the DLC film 59 over regions corresponding to the aforementioned front and auxiliary rear air bearing surfaces 43, 44, 44.

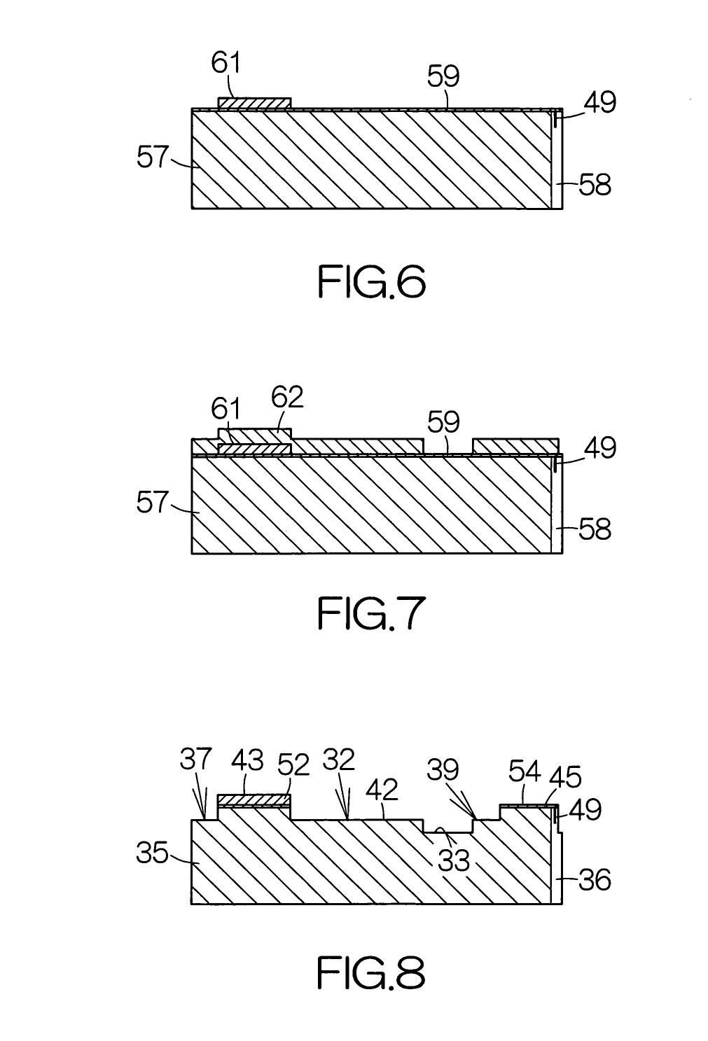

As shown in FIG. 7, a photoresist film 62 is formed over a predetermined region. The material of the wafer bar 57 and the alumina film 58 is removed outside the contour of the photoresist film 62. Milling process is employed, for example. The rails 37-39, 41, 42 are in this manner shaped. As shown in FIG. 8, the bottom surface 32 has been established on the cutting surface of the wafer bar 57. The DLC films 59, 61 form the first and third protection films 52, 56. The mere DLC film 59 forms the second protection film 54. The slider body 31 is then cut out of the wafer bar 57. The flying head slider 21 is produced in this manner.

The method allows formation of the DLC films 59, 61 over the flat surfaces of the wafer bar 57 and the alumina film 58. The overall thickness of the DLC films 59, 61 corresponds to the thickness of the first and third protection films 52, 56. The thickness of the DLC film 59 corresponds to the thickness of the second protection film 54. Adjustment of the thickness of the DLC films 59, 61 is utilized to control the first and second heights H1, H2. Specifically, the heights of the air bearing surfaces 43, 45, 44 from the base surface 33 can be adjusted in a facilitated manner. Even if the flying head slider 21 is subjected to a design change, the method is still applicable without any difficulty.

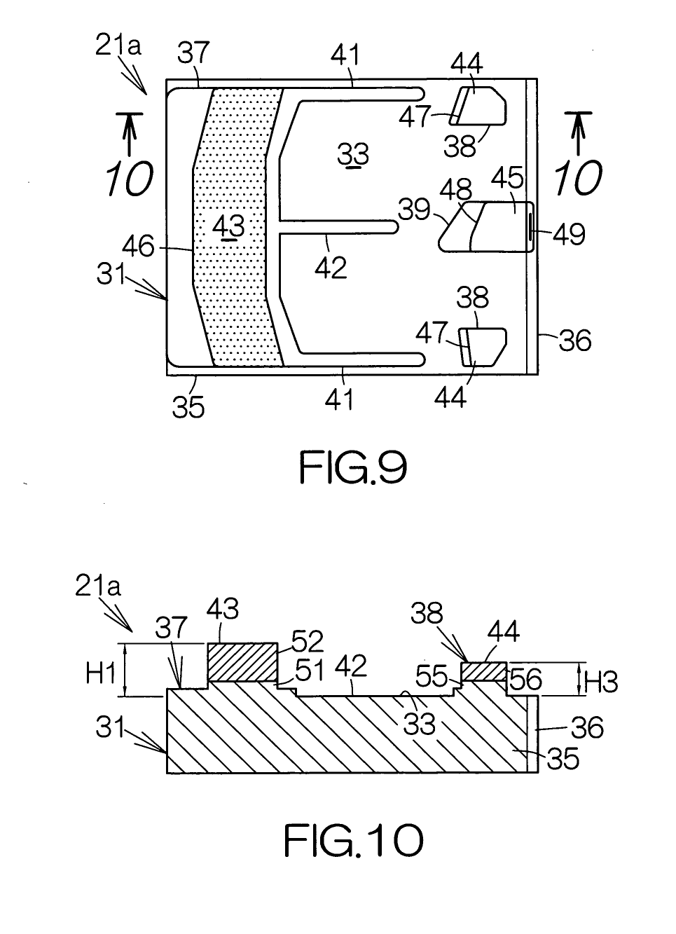

FIG. 9 illustrates a flying head slider 21a according to a second embodiment of the present invention. The flying head slider 21a may be incorporated in the hard disk drive 11 in place of the aforementioned flying head slider 21. As mentioned in FIG. 9, the front air bearing surface 43 is set at the highest position from the base surface 33 in the flying head slider 21a. As shown in FIG. 10, the auxiliary rear air bearing surfaces 44, 44 are set at a third height H3 smaller than the first height H1 from the base surface 33. The rear air bearing surface 45 may be set at the aforementioned second height H2. The third height H3 is set larger than the second height H2. Like reference numerals are attached to the structure or components equivalent to those of the aforementioned flying head slider 21.

The rear air bearing surface 45 is distanced from the surface of the magnetic recording disk 13 by an amount larger than the distance between the front and auxiliary rear air bearing surfaces 43, 44 and the surface of the magnetic recording disk 13 in the flying head slider 21a in the same manner as described above. The electromagnetic transducer 49 is thus prevented from contact or collision against the magnetic recording disk 13 to the utmost even when the electromagnetic transducer 49 protrudes out of the rear air bearing surface 45 in response to the expansion of the head protection film 36.

The front and auxiliary rear air bearing surfaces 43, 44 are defined at positions higher than the position of the rear air bearing surface 45. As long as the electromagnetic transducer 49 is kept at a distance from the magnetic recording disk 13 as ever, the front and auxiliary rear air bearing surfaces 43, 44, 44 are allowed to get closer to the magnetic recording disk 13. In addition, the front air bearing surface 43 is defined at a position higher than the positions of the auxiliary rear and rear air bearing surfaces 44, 45. The front air bearing surface 43 is allowed to get closer to the surface of the magnetic recording disk 13 regardless of establishment of the pitch angle α. Accordingly, the flying height of the flying head slider 21a can be reduced. The flying head slider 21a is in this manner allowed to enjoy a stable flying attitude.

Adjustment on the thickness of the aforementioned photoresist film 62 may be utilized to realize the flying head slider 21a, for example. The photoresist film 62 having a first resist thickness may be formed on the front air bearing surface 43, for example. Simultaneously, the photoresist film 62 having a second resist thickness smaller than the first resist thickness may be formed on the individual auxiliary rear air bearing surface 44, for example. Differences can in this manner be realized between the thicknesses of the first to third protection films 52, 54, 56. The differences between the thicknesses of the first to third protection films 52, 54, 56 can be utilized to establish the differences between the first to third heights H1, H2, H3. The intensity of exposure applied to a photoresist material may be changed for the adjustment of the thickness of the photoresist film 62, for example. A so-called half-tone mask may be employed.

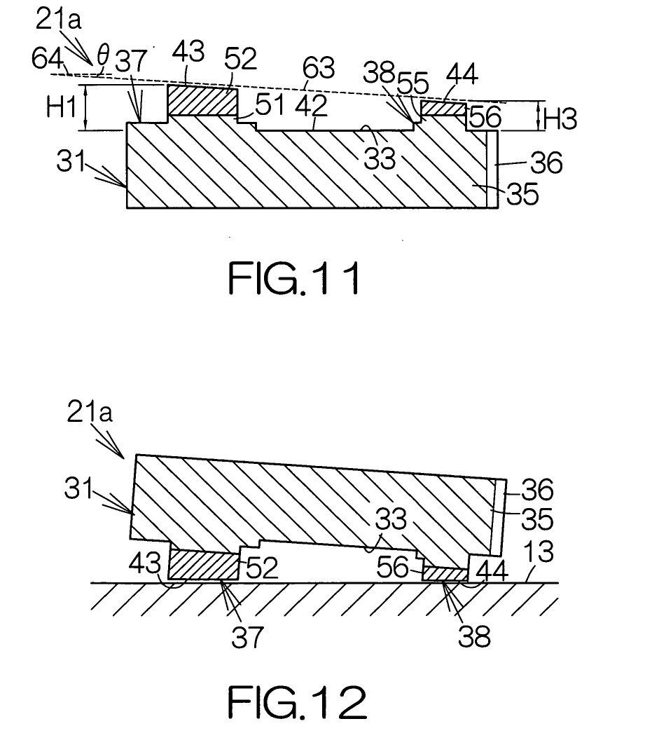

As shown in FIG. 11, the front and auxiliary rear air bearing surfaces 43, 44, 44 may extend within an imaginary plane 63 getting closer to the base surface 33 at a position closer to the outflow end and remoter from the inflow end of the slider body 31 in the flying head slider 21a. The imaginary plane 63 is defined to establish an inclination angle θ equal to the aforementioned pitch angle α relative to an imaginary plane 64 parallel to the base surface 33. The first and third heights H1, H3 may be defined to correspond to the maximum height of the front and auxiliary rear air bearing surfaces 43, 44 from the base surface 33. Like reference numerals are attached to the structure or components equivalent to those of the aforementioned flying head slider 21.

The rear air bearing surface 45 is distanced from the surface of the magnetic recording disk 13 by an amount larger than the distance between the front and auxiliary rear air bearing surfaces 43, 44 and the surface of the magnetic recording disk 13 in the same manner as described above. The electromagnetic transducer 49 is thus prevented from contact or collision against the magnetic recording disk 13 to the utmost even when the electromagnetic transducer 49 protrudes out of the rear air bearing surface 45 in response to the expansion of the head protection film 36.

The front and auxiliary rear air bearing surfaces 43, 44, 44 are set at the first height H1 larger than the second height H2 of the rear air bearing surface 45 as described above. As long as the electromagnetic transducer 49 is kept at a distance from the magnetic recording disk 13 as ever, the front and auxiliary rear air bearing surfaces 43, 44, 44 are allowed to get closer to the magnetic recording disk 13. In addition, when the flying head slider 21a is kept in the flying attitude of the pitch angle α above the rotating magnetic recording disk 13, the front air bearing surface 43 can be distanced form the magnetic recording disk 13 by an amount equal to the distance between the auxiliary rear air bearing surfaces 44 and the magnetic recording disk 13, as shown in FIG. 12. The front air bearing surface 43 is allowed to get closer to the surface of the magnetic recording disk 13 regardless of establishment of the pitch angle α. Accordingly, the flying height of the flying head slider 21a can be reduced. The flying head slider 21a is allowed to enjoy a stable flying attitude.

Adjustment on the thickness of the aforementioned photoresist film 62 may be utilized to realize the flying head slider 21a, for example. The first and third protection films 52, 56 are first formed at a relatively large thickness. The photoresist film 62 is formed on each of the first and third protection films 52, 56. The thickness of the photoresist film 62 may be reduced at a position closer to the outflow end, for example. The first and third protection films 52, 56 are formed based on the tapered photoresist films 62. The flying head slider 21a is produced in this manner.

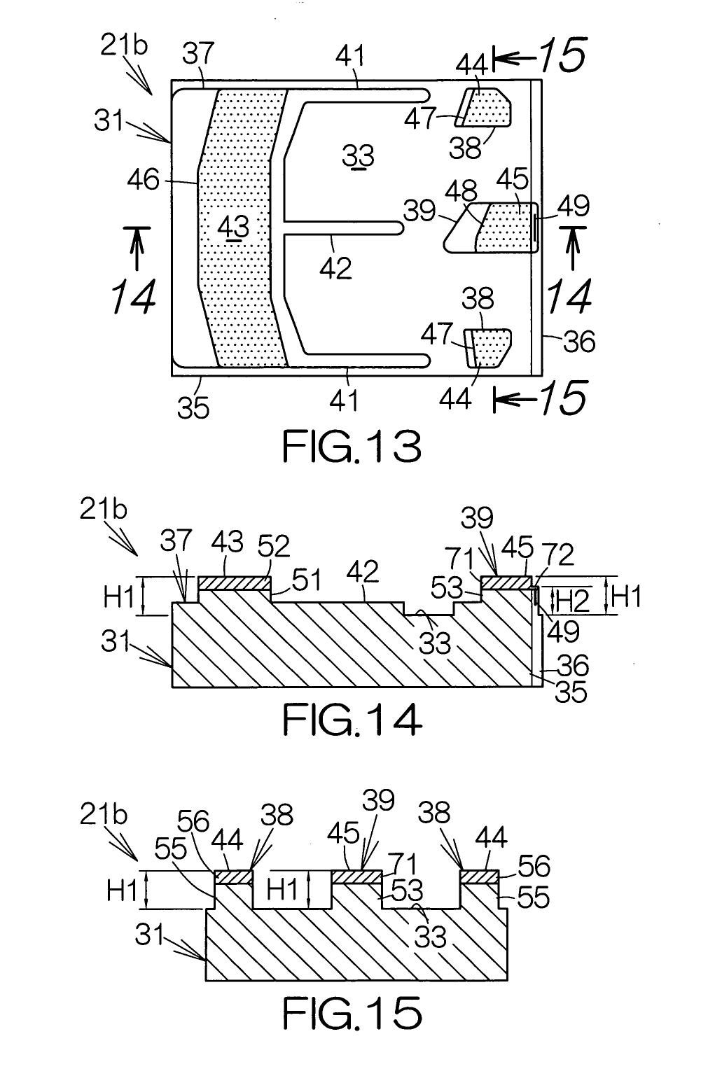

FIG. 13 schematically illustrates a flying head slider 21b according to a third embodiment of the present invention. The front, auxiliary rear and rear air bearing surfaces 43, 44, 44, 45 are set at the highest position from the base surface 33 in the flying head slider 21b. As shown in FIG. 14, the front and rear air bearing surfaces 43, 45 are set at the first height H1 from the base surface 33. The electromagnetic transducer 49 is embedded in the rear center rail 39 at the second height H2 lower than the first height H1 from the base surface 33 at a position distanced from the rear air bearing surface 45.

The rear center rail 39 includes the aforementioned rear pedestal 53 and first and second protection films 71, 72 formed on the rear pedestal 53. The first protection film 71 has the first thickness. The second protection film 72 has the second thickness smaller than the first thickness. The surface of the first protection film 71 serves to provide the rear air bearing surface 45. The second protection film 72 covers over the front end of the electromagnetic transducer 49 on the rear center rail 39. The first and second protection films 71, 72 may be made of diamond-like-carbon (DLC), for example.

As shown in FIG. 15, the rear and auxiliary rear air bearing surfaces 45, 44, 44 are set at the first height H1 from the base surface 33. The air bearing surfaces 43, 44, 45 thus extend within an imaginary plane, not shown, extending in parallel with the base surface 33 at the first height H1. The difference between the first and second heights H1, H2 may be set equal to the maximum amount of the protrusion of the electromagnetic transducer 49 in the same manner as described above. Like reference numerals are attached to the structure or components equivalent to those of the aforementioned flying head sliders 21, 21a.

The air bearing surfaces 43, 44, 45 are set at the first height H1 from the base surface 33 in the flying head slider 21b. The electromagnetic transducer 49 is embedded in the rear center rail 39 at the second height H2 lower than the first height H1 from the base surface 33 at a position distanced from the rear air bearing surface 45. The front end of the electromagnetic transducer 49 is distanced from the surface of magnetic recording disk 13 by an amount larger than the distance between each of the air bearing surfaces 43, 44, 44, 45 and the magnetic recording disk 13. The electromagnetic transducer 49 is thus prevented from contact or collision against the magnetic recording disk 13 to the utmost even when the electromagnetic transducer 49 protrudes in response to the expansion of the head protection film 36.

The front, auxiliary rear and rear air bearing surfaces 43, 44, 44, 45 are set at the first height H1 larger than the second height H2 of the electromagnetic transducer 49. As long as the electromagnetic transducer 49 is kept at a distance from the magnetic recording disk 13 as ever, the front, auxiliary rear and rear air bearing surfaces 43, 44, 44, 45 are allowed to get closer to the magnetic recording disk 13. Accordingly, the flying head slider 21b is allowed to enjoy a stable flying attitude. In addition, the second protection film 72 covers over the electromagnetic transducer 49. The second protection film 54 is allowed to have a sufficient thickness, so that the second protection film 72 serves to prevent corrosion of the electromagnetic transducer 49.

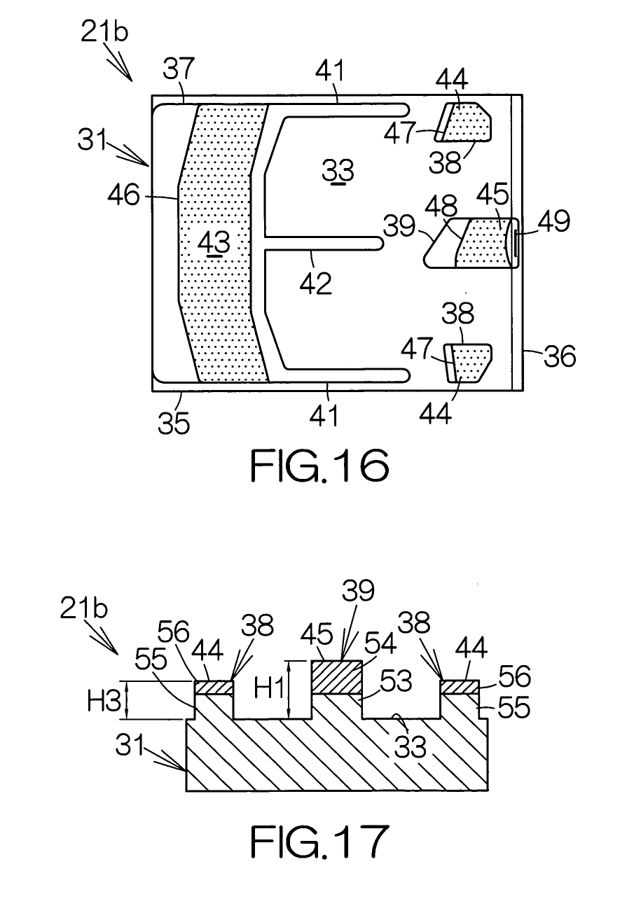

As shown in FIG. 16, the outflow end of the first protection film 71 may be depressed toward the inflow end of the first protection film 71 in the aforementioned flying head slider 21b. The electromagnetic transducer 49 can in this manner be distanced from the first protection film 71 by a predetermined amount. An observation by the inventor has revealed that the protrusion of the electromagnetic transducer 49 extends over a range away from the electromagnetic transducer 49 by a predetermined distance toward the inflow end. Accordingly, as long as the electromagnetic transducer 49 is kept away from the first protection film 71 by a predetermined distance, the first protection film 71 can be prevented from suffering from protrusion. The electromagnetic transducer 49 is allowed to reliably protrude at a position outside the periphery of the first protection film 71 or the rear air bearing surface 45.

As shown in FIG. 17, the auxiliary rear air bearing surfaces 44 may be set at the third height H3 smaller than the first height H1 from the base surface 33 in the aforementioned flying head slider 21b. The third height H3 may be set larger than the second height H2. The auxiliary rear air bearing surfaces 44 are in this manner set at positions lower than that of the rear air bearing surface 45. The rear air bearing surface 45 is thus allowed to get closer to the magnetic recording disk 13 even when the flying head slider 21b get closest to the magnetic recording disk 13 at the auxiliary rear air bearing surface 44 based on establishment of the roll angle β. Accordingly, the flying height of the flying head slider 21b can be reduced. Like reference numerals are attached to the structure or components equivalent to those of the aforementioned flying head sliders 21, 21a.

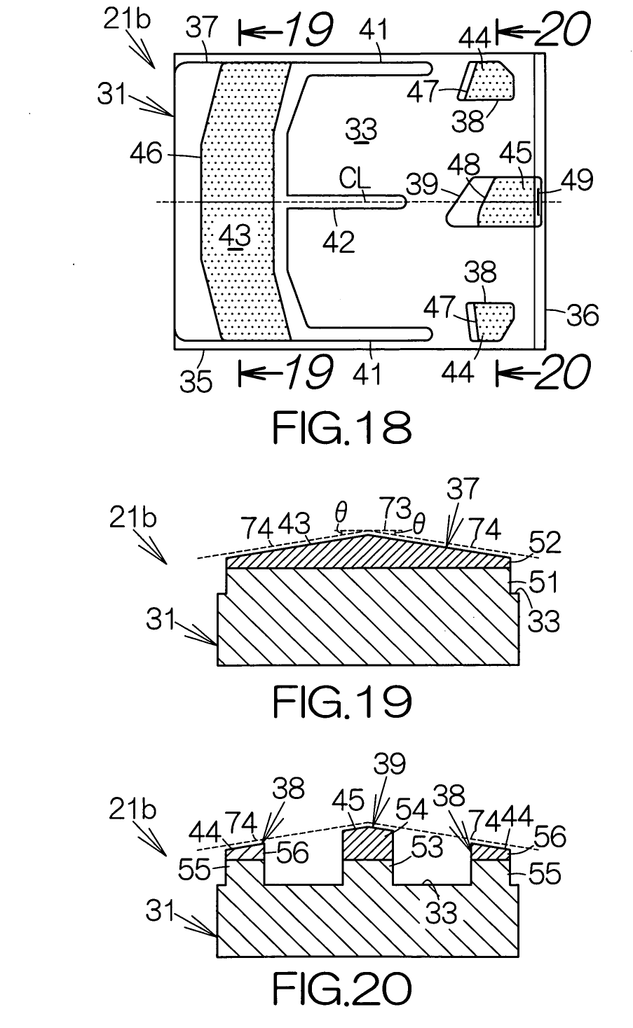

As mentioned in FIG. 18, the air bearing surfaces 43, 44, 45 may respectively get closer to the base surface 33 at a position closer to the side edge of the slider body 31 and remoter from the longitudinal centerline CL of the slider body 31. The longitudinal centerline CL extends from the inflow end toward the outflow end of the slider body 31 so as to halve the bottom surface 32 in the aforementioned flying head slider 21b. The longitudinal centerline CL extends on the base surface 33 from the middle of the inflow end to the middle of the outflow end. As shown in FIG. 19, the front air bearing surface 43 is defined along imaginary planes 74, 74 each getting closer to the base surface 33 at a position more distant from the longitudinal centerline CL. The individual imaginary plane 74 is defined to establish a predetermined inclination angle θ equal to the roll angle β relative to an imaginary plane 73 parallel to the base surface 33.

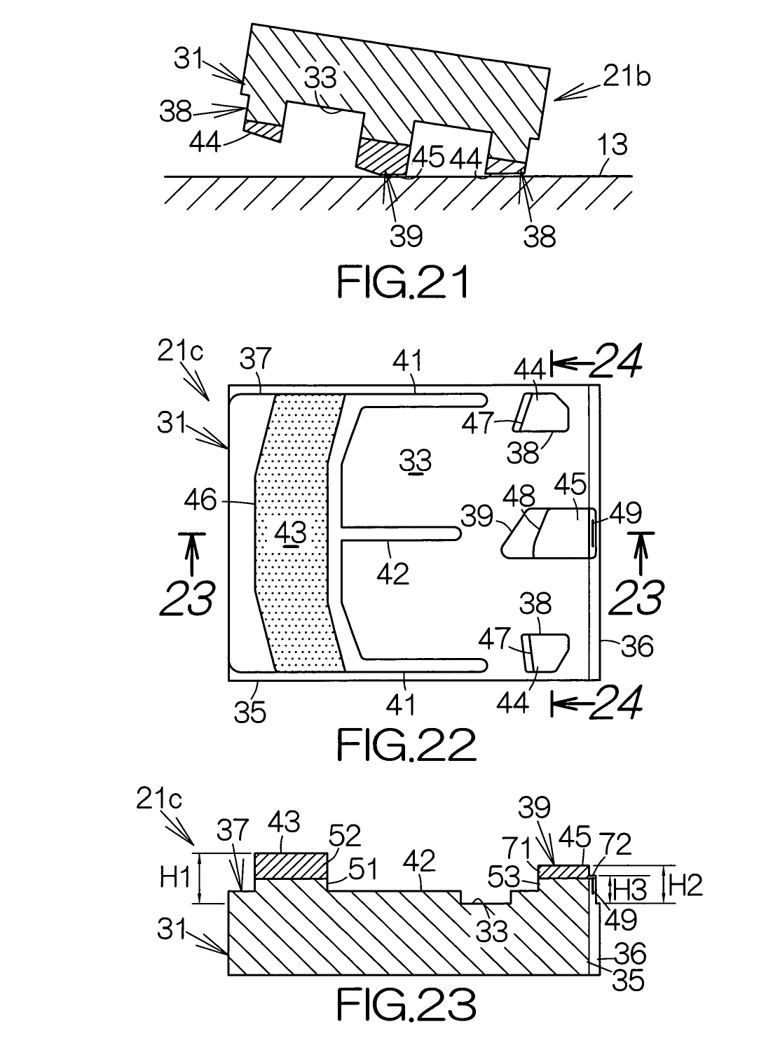

The auxiliary rear and rear air bearing surfaces 44, 44, 45 are likewise defined along the imaginary planes 74, 74, as shown in FIG. 20. When the flying head slider 21b is kept in a flying attitude of the roll angle β above the rotating magnetic recording disk 13, as shown in FIG. 21, the auxiliary rear air bearing surfaces 44 can be distanced from the magnetic recording disk 13 by an amount equal to the distance between the rear air bearing surface 45 and the magnetic recording disk 13. The rear air bearing surface 45 is in this manner allowed to get closer to the magnetic recording disk 13. The electromagnetic transducer 49 is thus allowed to get closer to the magnetic recording disk 13. Like reference numerals are attached to the structure or components equivalent to those of the aforementioned flying head sliders 21, 21a.

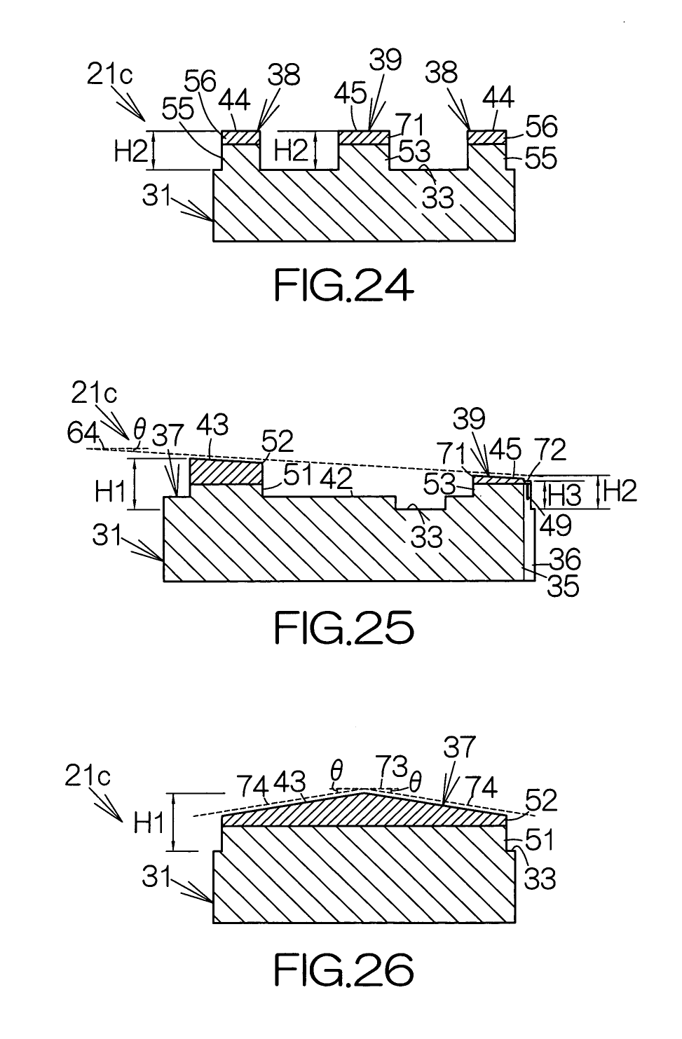

FIG. 22 schematically illustrates a flying head slider 21c according to a fourth embodiment of the present invention. The front air bearing surface 43 is set at the highest position from the base surface 33 in the flying head slider 21c. As shown in FIG. 23, the front air bearing surface 43 is set at the first height H1 from the base surface 33. The rear air bearing surface 45 is set at the second height H2 smaller than the first height H1. The electromagnetic transducer 49 is embedded in the rear center rail 39 at the third height H3 lower than the second height H2 at a position distanced from the rear air bearing surface 45. As shown in FIG. 24, the auxiliary rear air bearing surfaces 44, 44 are also set at the second height H2 in the same manner as the rear air bearing surface 45. Like reference numerals are attached to the structure or components equivalent to those of the aforementioned flying head sliders 21, 21a, 21b.

The rear air bearing surface 45 is set at the second height H2 from the base surface 33 in the flying head slider 21c. The electromagnetic transducer 49 is embedded in the rear center rail 39 at the third height H3 smaller than the second height H2 at a position distanced from the rear air bearing surface 45. The front end of the electromagnetic transducer 49 is distanced from the surface of magnetic recording disk 13 by an amount larger than the distance between the rear air bearing surface 45 and the magnetic recording disk 13. The electromagnetic transducer 49 is thus prevented from contact or collision against the magnetic recording disk 13 to the utmost even when the electromagnetic transducer 49 protrudes in response to the expansion of the head protection film 36.

The front, auxiliary rear and rear air bearing surfaces 43, 44, 44, 45 are set at positions higher than the position of the electromagnetic transducer 49. As long as the electromagnetic transducer 49 is kept at a distance from the magnetic recording disk 13 as ever, the front, auxiliary rear and rear air bearing surfaces 43, 44, 44, 45 are allowed to get closer to the magnetic recording disk 13. In addition, the front air bearing surface 43 is set at a position higher than the positions of the auxiliary rear and rear air bearing surfaces 44, 44, 45. The front air bearing surface 43 is thus allowed to get closer to the surface of the magnetic recording disk 13 regardless of establishment of the pitch angle α. Accordingly, the flying height of the flying head slider 21c can be reduced. The flying head slider 21c is allowed to enjoy a stable flying attitude. The outflow end of the first protection film 71 may be depressed toward the inflow end of the first protection film 71 in the same manner as described above in the flying head slider 21c.

As shown in FIG. 25, the front, auxiliary rear and rear air bearing surfaces 43, 44, 44, 45 may extend in the imaginary plane 63 getting closer to the base surface 33 at a position closer to the outflow end and remoter from the inflow end of the slider body 31 in the aforementioned flying head slider 21c. The imaginary plane 63 may be defined to establish an intersection angle θ equal to the aforementioned pitch angle α relative to the imaginary plane 64 parallel to the base surface 33. The first and second heights H1, H2 may be defined to correspond to the maximum height of the air bearing surfaces 43, 44, 45 from the base surface 33. Like reference numerals are attached to the structure or components equivalent to those of the aforementioned flying head sliders 21, 21a, 21b.

The front end of the electromagnetic transducer 49 is distanced from the surface of magnetic recording disk 13 by an amount larger than the distance between the rear air bearing surface 45 and the magnetic recording disk 13 in the flying head slider 21c. The electromagnetic transducer 49 is thus prevented from contact or collision against the magnetic recording disk 13 to the utmost even when the electromagnetic transducer 49 protrudes in response to the expansion of the head protection film 36.

The front, auxiliary rear and rear air bearing surfaces 43, 44, 44, 45 are set at positions higher than the position of the electromagnetic transducer 49. As long as the electromagnetic transducer 49 is kept at a distance from the magnetic recording disk 13 as ever, the front, auxiliary rear and rear air bearing surfaces 43, 44, 44, 45 are allowed to get closer to the magnetic recording disk 13. In addition, when the flying head slider 21c is kept in the flying attitude of the pitch angle α above the rotating magnetic recording disk 13, the front air bearing surface 43 can be distanced from the magnetic recording disk 13 by an amount equal to the distance between the each of the auxiliary rear and rear air bearing surfaces 44, 45. The front air bearing surface 43 is thus allowed to get closer to the magnetic recording disk 13. Accordingly, the flying height of the flying head slider 21c can be reduced. The flying head slider 21c is allowed to enjoy a stable flying attitude. The outflow end of the first protection film 71 may be depressed toward the inflow end of the first protection film 71 in the flying head slider 21c in the same manner as described above.

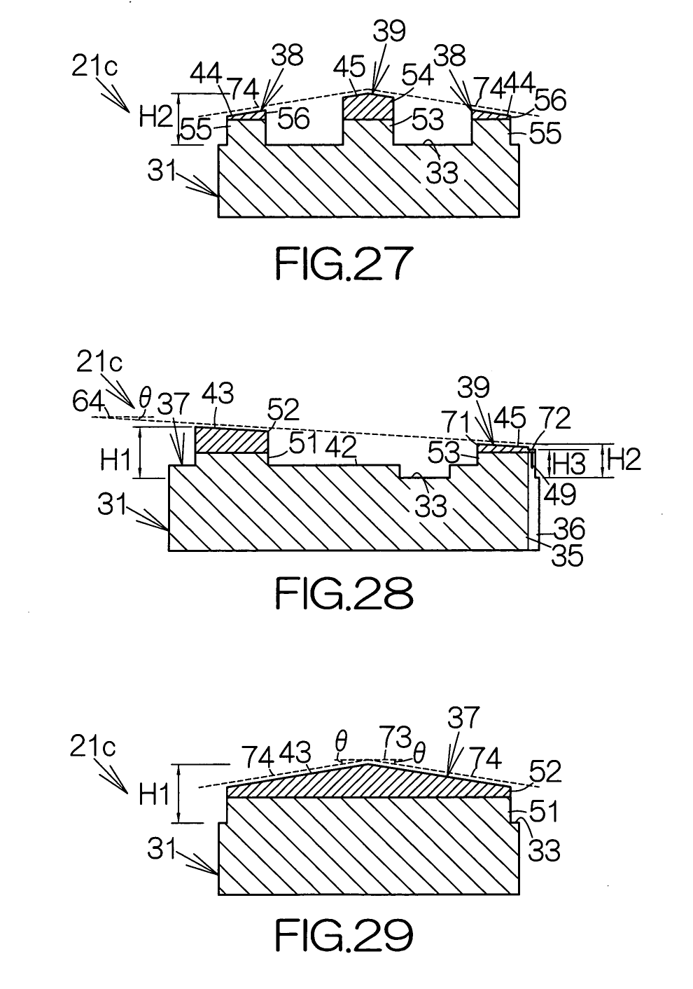

As shown in FIG. 26, the front air bearing surface 43 may get closer to the base surface 33 at a position closer to the side edge of the slider body 31 and remoter from the longitudinal centerline CL of the slider body 31 in the aforementioned flying head slider 21c. As shown in FIG. 27, the auxiliary rear and rear air bearing surfaces 44, 45 may likewise get closer to the base surface 33 at positions closer to the side edge of the slider body 31 and remoter from the longitudinal centerline CL of the slider body 31. Like reference numerals are attached to the structure or components equivalent to those of the aforementioned flying head sliders 21, 21a, 21b.

As shown in FIGS. 28 and 29, the air bearing surfaces 43, 44, 45 may respectively get closer to the base surface 33 at a position closer to the side edge of the slider body 31 and remoter from the longitudinal centerline CL of the slider body 31 while the surfaces 43, 44, 45 get closer the base surface 33 at a position closer to the outflow end of the slider body 31 and remoter from the inflow end of the slider body 31. Ridgelines of the front and rear air bearing surfaces 43, 45 may extend within the aforementioned imaginary plane 63. The flying head slider 21c is allowed to enjoy the advantages identical to those obtained in the aforementioned embodiments.

What is claimed is:

1. A head slider comprising:
a slider body defining a reference surface;
a front rail located near an inflow end of the slider body, said front rail defining a front air bearing surface at a first height from the reference surface of the slider body;
a rear rail located near an outflow end of the slider body, said rear rail defining a rear air bearing surface at a second height smaller than the first height from the reference surface of the slider body; and
a head element embedded in the rear air bearing surface.

2. The head slider according to claim 1, further comprising a pair of rear side rails located near side edges and the outflow end of the slider body, said rear side rails each defining an auxiliary rear air bearing surface at the first height from the reference surface of the slider body.

3. The head slider according to claim 1, further comprising a pair of rear side rails located near side edges and the outflow end of the slider body, said rear side rails each defining an auxiliary rear air bearing surface defined at a third height from the reference surface of the slider body, the third height being smaller than the first height and larger than the second height.

4. The head slider according to claim 3, wherein the front and auxiliary rear air bearing surfaces extend within an imaginary plane getting closer to the reference surface at a position closer to the outflow end and remoter from the inflow end.

5. The head slider according to claim 1, further comprising a protection film formed on the slider body to define the rear air bearing surface, said protection film covering over the head element.

6. The head slider according to claim 1, further comprising:
a first protection film having a first thickness, said first protection film formed on the slider body to define the front air bearing surface; and
a second protection film having a second thickness smaller than the first thickness, said second protection film formed on the slider body to define the rear air bearing surface, said second protection film covering over the head element.

7. A head slider comprising:
a slider body defining a reference surface;
a front rail located near an inflow end of the slider body, said front rail defining a front air bearing surface at a first height from the reference surface of the slider body;
a rear rail located near an outflow end of the slider body, said rear rail defining a rear air bearing surface at the first height from the reference surface of the slider body; and
a head element embedded in the rear rail at a second height smaller than the first height from the reference surface of the slider body at a position off the rear air bearing surface.

8. The head slider according to claim 7, further comprising a pair of rear side rails located near side edges and the outflow end of the slider body, said rear side rails each defining an auxiliary rear air bearing surface at the first height from the reference surface of the slider body.

9. The head slider according to claim 7, further comprising a pair of rear side rails located near side edges and the outflow end of the slider body, said rear side rails each defining an auxiliary rear air bearing surface at a third height smaller than the first height from the reference surface of the slier body.

10. The head slider according to claim 9, wherein the rear and auxiliary rear air bearing surfaces respectively get closer to the reference surface at positions closer to the side edges of the slider body and remoter from a longitudinal centerline of the slider body, the longitudinal centerline extending from the inflow end to the outflow end.

11. The head slider according to claim 7, further comprising a protection film formed on the slider body to cover over the head element.

12. The head slider according to claim 7, further comprising:
a first protection film having a first thickness, said first protection film formed on the slider body to define the rear air bearing surface; and
a second protection film having a second thickness smaller than the first thickness, said second protection film formed on the slider body to cover over the head element.

13. A head slider comprising:
a slider body defining a reference surface;
a front rail located near an inflow end of the slider body, said front rail defining a front air bearing surface at a first height from the reference surface of the slider body;
a rear rail located near an outflow end of the slider body, said rear rail defining a rear air bearing surface at a second height smaller than the first height from the reference surface of the slider body; and
a head element embedded in the rear rail at a third height smaller than the second height from the reference surface of the slider body at a position off the rear air bearing surface.

14. The head slider according to claim 13, further comprising a pair of rear side rails located near side edges and the outflow end of the slider body, said rear side rails each defining an auxiliary rear air bearing surface at the second height from the reference surface of the slider body.

15. The head slider according to claim 14, wherein the front, rear and auxiliary rear air bearing surfaces extend within an imaginary plane getting closer to the reference surface at a position closer to the outflow end and remoter from the inflow end.

16. The head slider according to claim 14, wherein the rear and auxiliary rear air bearing surfaces respectively get closer to the reference surface at positions closer to the side edges of the slider body and remoter from a longitudinal centerline of the slider body, the longitudinal centerline extending from the inflow end to the outflow end.

17. The head slider according to claim 16, wherein the front, rear and auxiliary rear air bearing surfaces respectively get closer to the reference surface at a position closer to the outflow end and remoter from the inflow end.

18. The head slider according to claim 13, further comprising a protection film formed on the slider body to cover over the head element.

19. The head slider according to claim 13, further comprising:
a first protection film having a first thickness, said first protection film formed on the slider body to define the rear air bearing surface at a surface of the first protection film; and
a second protection film having a second thickness smaller than the first thickness, said second protection film formed on the slider body to cover over the head element.
